(19) United States
(12) Patent Application Publication
(10) Pub. No.: US 2004/0058816 A1
(43) Pub. Date: Mar. 25, 2004

(54) Image forming sheet, method for identifying the same, and image forming apparatus

(76) Inventors: Satoshi Narita, Tokyo-To (JP); Kazutoshi Awano, Tokyo-To (JP); Tatsuya Kita, Tokyo-To (JP)

Correspondence Address: HARNESS, DICKEY & PIERCE, P.L.C., P.O. BOX 828, BLOOMFIELD HILLS, MI, 48303, US

(21) Appl. No.: 10/667,220

(22) Filed: Sep. 17, 2003

(30) Foreign Application Priority Data
Sep. 18, 2002 (JP) 2002-272187

(51) Int. Cl. B41M 5/20

(52) U.S. Cl. 503/201

(57) ABSTRACT

There is provided an image forming sheet with a mark which can reliably identify the presence or absence of the image forming sheet and/or the type of the image forming sheet without sacrificing the design and a visual texture of the sheet. In the image forming sheet 1, an identification mark 2, which is less likely to be visually perceived from the external appearance of the sheet 1, is provided within the sheet 1. The image forming sheet 1 may have a laminate structure of a plurality of substrate sheets 3 between which the identification mark 2 is provided. The identification mark 2 absorbs an electromagnetic radiation with a wavelength λ1 and emits an electromagnetic radiation with a wavelength λ2 different from the wavelength λ1 and can reliably identify the presence or absence of the image forming sheet and/or the type of the image forming sheet without sacrificing the appearance and design of the sheet.

### TECHNICAL FIELD

The present invention relates to an image forming sheet having an identification mark which is less likely to be visually perceived under ordinary visible radiation from the external appearance of the image forming sheet. More particularly, the present invention relates to a method for identifying the presence or absence of an image forming sheet and/or the type of the image forming sheet, and an image forming apparatus.

### BACKGROUND ART

Conventional image formation methods for hard- copying images such as video images and digital photographs include various methods such as silver salt photography, electrophotography, thermal recording, thermal transfer recording, and ink jet recording. In these methods, respective specialty image forming sheets are used (plain paper may also be used in the electrophotography and ink jet recording). A plurality of types of image forming sheets are provided for respective image formation methods. Further, in many cases, a plurality of types of image forming sheets are provided for each image formation method, for example, for providing image formed sheets having a desired texture. Specific examples of types of image forming sheets include gloss types, matte types, OHP types, heavy-gage types, thin-gage types, and seal types.

The image forming sheet will be described by taking a thermal transfer recording method as an example. The image forming sheet used in the thermal transfer recording method is called a thermal transfer image-receiving sheet which is used in combination with a thermal transfer recording sheet. In this case, printing (image formation) is carried out by transferring a colorant in a desired image form from the thermal transfer recording sheet to the thermal transfer image-receiving sheet by means of a thermal head mounted on a printer (an image forming apparatus).

As described above, the type of the thermal transfer image-receiving sheet to be used varies depending upon the desired texture. Further, the type of the thermal transfer image-receiving sheet to be used sometimes varies depending upon whether or not a protective layer is provided after printing. Therefore, in some cases, many different types of thermal transfer image-receiving sheets are provided. In this case, the identification of the type of the thermal transfer image-receiving sheet is important. In general, the printing mode is changed according to the type of the thermal transfer image-receiving sheet used. When an erroneous mode is used, predetermined printing performance or durability cannot be provided and, further, there is a fear of causing malfunction or failure of the printer.

Conventional methods for identifying the type of a thermal transfer image-receiving sheet include: a method wherein a user identifies the indication of the type of the thermal transfer image-receiving sheet and inputs information on the type of the thermal transfer image-receiving sheet into a printing control mechanism such as a printer or a personal computer; and a method wherein an identification mark provided in the thermal transfer image-receiving sheet is mechanically recognized by a printer to automatically identify the type of the thermal transfer image-receiving sheet. In the method wherein the identification mark is used, in some cases, the presence or absence of the thermal transfer image-receiving sheet is identified simultaneously with the identification of the type of the thermal transfer image-receiving sheet.

In the method wherein a user identifies the type of the thermal transfer image-receiving sheet, there is fear of causing a human error. Therefore, this method is unreliable. In the method wherein an identification mark is used, a colored mark is generally provided on the thermal transfer image-receiving sheet in its site having no effect on printing, for example, in its backside. In this case, the mark can be of course easily visually perceived. Disadvantageously, this often adversely affects the design of the thermal transfer image-receiving sheet. Specifically, in many cases, a logo mark or a characteristic design is provided on the backside of the thermal transfer image-receiving sheet. The presence of the above mark significantly deteriorates the design and thus deteriorates the visual texture of the sheet.

Further, in the case of the above conventional mark, basically, the mark can be detected only from the mark-formed side, that is, usually from the backside of the thermal transfer image-receiving sheet. In some cases, the provision of a mark detection mechanism on the backside of the thermal transfer image-receiving sheet is difficult due to the design and mechanism of the printer.

A method, wherein the visibility of a mark or a pattern is lowered, is also known. An example of this method is that a pattern containing a material, which absorbs an infrared radiation with a first wavelength and emits an infrared radiation with a second wavelength different from the first wavelength, is provided in an object and a concealing layer for absorbing visible radiation is provided thereon (Japanese Patent Laid-Open No. 258592/1991).

In this method, infrared radiation not sensitive to the human's eyes is used for pattern recognition, and the visibility of the pattern is lowered by the provision of the concealing layer. This method, however, poses problems including that the presence of the concealing layer is unnatural and deteriorates the design and, on the contrary, images the concealment of information and the pattern cannot be fully concealed by the concealing layer without difficulties.

These problems are common to the above-exemplified thermal transfer image-receiving sheets and other image forming sheets used in various image formation methods.

In view of the above problems, an object of the present invention is to provide an image forming sheet having a mark which can reliably identify the presence or absence of the image forming sheet and/or the type of the image forming sheet without sacrificing the design and a visual texture of the sheet.

### DISCLOSURE OF THE INVENTION

According to one aspect of the present invention, there is provided an image forming sheet comprising an identification mark provided within said sheet, said mark being less likely to be visually perceived from the external appearance of said sheet.

In a preferred embodiment of the present invention, the image forming sheet has a laminate structure of a plurality of substrate sheets, and the identification mark is provided between said plurality of substrate sheets.

In another preferred embodiment of the present invention, the identification mark contains a material which can absorb an electromagnetic radiation with a wavelength λ1 and can emit an electromagnetic radiation with a wavelength λ2 different from the wavelength λ1.

Preferably, the electromagnetic radiation with a wavelength λ1 absorbed by the material is infrared radiation, and the electromagnetic radiation with a wavelength λ2 emitted from the material is also infrared radiation.

The image forming sheet according to the present invention is preferably a thermal transfer image receiving sheet.

According to another aspect of the present invention, there is provided an identification method comprising the steps of: providing the above image forming sheet; and detecting the identification mark provided in the image forming sheet with a sensor to identify the presence or absence of the image forming sheet and/or the type of the image forming sheet.

According to a further aspect of the present invention, there is provided an image forming apparatus comprising: a sensor which, when the above image forming sheet has been placed in said apparatus, detects the identification mark provided in the image forming sheet; a discrimination part for performing discrimination treatment for identifying the presence or absence of the image forming sheet and/or the type of the image forming sheet based on a signal detected by the sensor; and a control unit for determining the operation of image formation based on the result of discrimination treatment.

In the present invention, the provision of an identification mark containing a material, which absorbs an infrared radiation with a wavelength λ1 and emits an infrared radiation with a wavelength λ2 different from the wavelength λ1, within an image forming sheet having a laminate structure of a plurality of substrates can realize reliable identification of the presence or absence of the image forming sheet and/or the type of the image forming sheet without sacrificing the appearance and design of the sheet. Specifically, since the material is substantially colorless or white under visible radiation, the presence or absence of an image forming sheet and/or the type of the image forming sheet can be reliably identified without sacrificing the design and appearance of the sheet, while reducing the visibility of the mark under visible radiation, by using an image forming sheet, prepared by printing a mark, on a substrate, using a mark forming ink containing this material, further stacking other substrate(s) and optionally forming an image forming layer, and a mark detecting mechanism comprising a combination of a light source for applying an infrared radiation with a wavelength λ1 and a detector for detecting an infrared radiation with a wavelength λ2.

Further, since the infrared radiation has higher light transmittance for long wavelengths than the visible radiation, the use of the image forming sheet according to the present invention enables, for example, the mark to be detected also from the image forming sheet on its side remote from the mark. Furthermore, when the above material is substantially invisible to the human's naked eye but has a very small excitation waveband in the visible light region, the material also emits infrared radiation upon exposure to visible radiation. Therefore, the freedom in selection of a light source necessary for the mark detection can be enhanced. The present invention is also useful for this application.

### BRIEF DESCRIPTION OF THE DRAWINGS

FIG. 1 is a schematic cross-sectional view showing one embodiment of the image forming sheet according to the present invention;

FIG. 2 is a schematic cross-sectional view showing another embodiment of the image forming sheet according to the present invention;

FIG. 3 is a flow chart showing an embodiment of the method for identifying the presence or absence of an image forming sheet and/or the type of the image forming sheet; and

FIG. 4 is a block diagram showing one embodiment of the image forming apparatus according to the present invention.

### BEST MODE FOR CARRYING OUT THE INVENTION

The present invention will be described in more detail with reference to the following preferred embodiments.

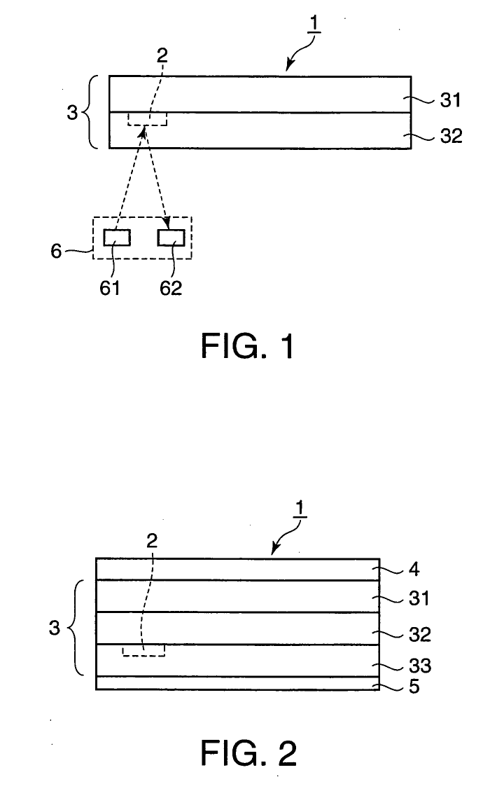

FIG. 1 is a schematic cross-sectional view showing one embodiment of the image forming sheet according to the present invention. In FIG. 1, an image forming sheet 1 includes a substrate sheet 3. The substrate sheet 3 comprises two sheets, a substrate sheet A (31) and a substrate sheet B (32). An identification mark 2 is provided between the substrate sheet A (31) and the substrate sheet B (32). The identification mark 2 is less likely to be visually perceived from the external appearance under visible radiation. In FIG. 1, a sensor 6 is shown. An electromagnetic radiation with a wavelength λ1 emitted from a light emitting part 61 in the sensor 6 is applied to the identification mark 2 provided within the image forming sheet 1. The applied radiation is absorbed in the identification mark 2 part, and an electromagnetic radiation with a wavelength λ2 different from λ1 is emitted from the identification mark 2 part and is detected in a light receiving part 62 of the sensor 6. The receiving part 62 detects the electromagnetic radiation with a wavelength of λ2 different from λ1.

FIG. 2 is a schematic cross-sectional view showing another embodiment of the image forming sheet according to the present invention. In FIG. 2, an image forming sheet 1 includes a substrate sheet 3. The substrate sheet 3 comprises three sheets, a substrate sheet A (31), a substrate sheet B (32), and a substrate sheet C (33). An identification mark 2 is provided between the substrate sheet B (32) and the substrate sheet C (33). The identification mark 2 is less likely to be visually perceived from the external appearance under visible radiation. Further, a receptive layer 4 for improving the receptivity to and fixation of an ink transferred in the image formation is provided on the substrate sheet A (31), and a backside layer 5 for imparting slipperiness and writing quality is provided on the lower surface of the substrate sheet C (33).

Individual elements constituting the image forming sheet according to the present invention will be described.

For simplification, recording methods and materials mainly in thermal transfer recording, especially a thermal dye sublimation transfer recording method, will be described. The present invention, however, is not limited to this only and may be applied to various conventional image formation methods such as thermal ink transfer recording methods, ink jet recording methods, electrophotographic recording methods, thermal (coloring) recording methods, and silver salt photographic recording methods.

### Substrate

Materials usable in the substrate sheet of the image forming sheet according to the present invention include, for example, papers such as both various papers per se and converted papers, for example, wood free papers, coated papers, art papers, cast coated papers, plain papers such as paperboards, and impregnated papers such as resin emulsion- or synthetic rubber latex-impregnated papers, and papers with synthetic resin internally added thereto. Further, laminate sheets prepared by laminating these papers onto various plastic films may also be used.

Further, synthetic papers such as polystyrene and polyolefin papers may be suitably used. Plastic films usable herein include polyolefin resin films, polyvinyl chloride films, polyester resin films, polystyrene films, polycarbonate films, polyacrylonitrile films, and polymethacrylate films. These plastic films are not particularly limited to transparent films only, and white opaque films, formed by adding white pigments, fillers or the like to these synthetic resins and forming films from the mixtures, and films having voids in their inside may also be used. When the image forming sheet is used as a thermal transfer image-receiving sheet, however, the use of a void-containing film is preferred from the viewpoint of good contact with a thermal head and effective utilization of energy by insulating effect.

Each of these materials as such may be used. A laminate of a combination of these materials with other material may also be preferably used. The use of a laminate formed of a combination of materials, which are properly selected from the above papers, synthetic papers, and plastic films, is also possible.

For example, a laminate prepared by laminating the above void-containing plastic film onto plain paper as a core material, for example, by a dry lamination method may be used as a substrate sheet. The void-containing plastic film is generally whitish due to voids contained in the film and a white pigment which is also generally contained in the film. This is also preferred from the viewpoint of concealing the mark, which will be described later, from the human's eyes. Further, in the formation of a dye-receptive layer or a backside layer on the substrate sheet, if necessary, corona discharge treatment of the substrate sheet or the provision of a primer coating or an intermediate layer may be carried out. The thickness of the substrate sheet is generally in the range of about 10 to 400 μm, preferably in the range of about 100 to 300 μm.

### Dye-receptive Layer

In the image forming sheet according to the present invention, a receptive layer may be provided to improve the receptivity of the image forming sheet to an ink transferred in the image formation and/or the fixation of the ink onto the image forming sheet. When the image forming sheet is used with a thermal dye sublimation transfer method, the receptive layer is a dye-receptive layer and may be any conventional one used with the thermal dye sublimation transfer method without particular limitation. Examples of materials usable for the dye-receptive layer include polyester resins, polyacrylic ester resins, polycarbonate resins, polyvinyl acetate resins, styrene acrylate resins, vinyltoluene acrylate resins, polyurethane resins, polyamide resins, polycaprolactone resins, styrene-maleic anhydride resins, polyvinyl chloride resins, and polyacrylonitrile resins. In addition to the above synthetic resins, for example, mixtures of the above resins or copolymers of monomers constituting the above resins may also be used.

In the image formation, the dye-receptive layer is put on top of a thermal transfer sheet, and the assembly is heat-pressed by means of a thermal head or the like. Therefore, at that time, the dye-receptive layer is likely to stick to the surface of the thermal transfer sheet. To avoid this sticking, in the formation of the dye-receptive layer, a release agent is generally added to the above resin. Release agents usable herein include solid waxes, fluorosurfactants or phosphoric ester surfactants, and silicone oils.

The amount of the release agent added is 0.1 to 30% by weight, preferably 1 to 15% by weight, based on the weight of the resin. When the amount of the release agent added is below the lower limit of the above-defined amount range, the release effect is unsatisfactory. On other hand, when the amount of the release agent added is above the upper limit of the above-defined amount range, the receptivity of the dye-receptive layer to dye is lowered. In both the above cases, adverse effect such as unsatisfactory record density occurs.

The dye-receptive layer may be formed on the substrate sheet, for example, by dissolving these materials in an organic solvent or dispersing these materials in an organic solvent or water to prepare a coating liquid, coating the coating liquid onto the substrate sheet by gravure printing, screen printing, reverse roll coating using a gravure plate, die coating or the like, and drying the coating. For some materials, the dye-receptive layer may be formed by melt extrusion without the use of the organic solvent or water. The dye-receptive layer may have any thickness. The thickness, however, is generally 1 to 50 μm.

### Backside Layer

In some cases, the provision of a backside layer is preferred. That is, a suitable level of slipperiness and a suitable level of writing quality for various writing implements can be imparted by providing the backside layer. The backside layer may include a main resin, various additives and a filler and may be formed by the same method as used in the formation of the dye-receptive layer.

Specific examples of main resins include polyacrylic ester resins, polystyrene resins, polyolefin resins, polyamide resins, polyvinyl butyral resins, polyvinyl alcohol resins, and cellulose acetate resins. Cured products prepared by curing these resins with various crosslinking agents or by various curing means such as radiation irradiation are also preferred. A mixture of two or more resins may also be used.

Additives usable herein include antistatic agents, release agents, and surfactants.

Fillers include extender pigments such as calcium carbonate and talc, white pigments such as titanium oxide, and various other inorganic pigments such as barium sulfate. Further, organic fillers such as nylon beads or polyethylene wax are also preferred.

The backside layer may be generally formed by adding a filler and additives to a main resin, dissolving the mixture in an organic solvent or dispersing the mixture in an organic solvent or water to prepare a coating liquid, coating the coating liquid onto the substrate sheet by gravure printing, screen printing, reverse roll coating using a gravure plate, die coating or the like, and drying the coating. For some materials, the backside layer may be formed by melt extrusion without the use of any solvent or dispersing medium. The thickness of the backside layer is generally about 1 to 70 μm.

### Identification Mark

In order to form an identification mark, which is less likely to be visually perceived from the external appearance under ordinary visible radiation, the use of a material, which is substantially colorless or white and has such an optical function as absorption, reflection or luminescence upon exposure to electromagnetic radiation in a wavelength region not sensitive to the human's eyes, as a “colorant” is preferred. In this case, an example of the colorant is an ultraviolet-visible fluorescent colorant which, upon exposure to ultraviolet radiation, absorbs the ultraviolet radiation and emits visible radiation. This ultraviolet-visible fluorescent colorant, however, is not preferred, because emitted light can be visually perceived under visible radiation and the presence of the mark cannot be fully concealed. That is, the use of a colorant, which, upon exposure to electromagnetic radiation in a wavelength region not sensitive to the human's eyes, can develop an optical function, such as absorption, reflection, or luminescence, in a wavelength region not sensitive to the human's eyes, is preferred.

An infrared-infrared fluorescent colorant, which has no strong absorption in a visible light region, is substantially colorless or white, and, upon exposure to an infrared radiation with a first wavelength, absorbs the infrared radiation and emits an infrared radiation with a second wavelength different from the first wavelength, is also preferably used. Another reason why the use of the infrared-infrared fluorescent colorant is preferred is as follows. As compared with ultraviolet radiation and visible radiation, infrared radiation has longer wavelength, is less likely to be scattered, and has better transmission. Therefore, even when an identification mark using an infrared-infrared fluorescent colorant is provided within the image forming sheet rather than on the outermost surface of the image forming sheet, the function of the mark can be developed. Specifically, when an infrared radiation with a specific wavelength λ1 is applied, the infrared radiation is passed through a constituent material such as a substrate, arrives at the identification mark which then emits an infrared radiation with a wavelength λ2 different from the wavelength λ1. The mark-derived infrared radiation with a wavelength λ2 is also passed through the constituent material and is radiated to the outside of the sheet. The mark-derived infrared radiation with a wavelength λ2 is detected with an infrared detector which is sensitive to the wavelength λ2.

Useful infrared-infrared colorants include, for example, inorganic infrared-infrared fluorescent colorants having a composition of Nd_{1-y}Yb_{y}Na₂Mg₂(Vo₄)₃ as described in Japanese Patent Publication No. 4598/1981. Further, for example, colorants having compositions of LiNd_{0.9}Yb_{0.1}P₄O₁₂, LiBi_{0.2}Nd_{0.7}Yb_{0.1}P₄O₁₂, NaNd_{0.9}Yb_{0.1}P₄O₁₂, Nd_{0.8}Yb_{0.2}Na_{5 (WO}₄)₄, Nd_{0.8}Yb_{0.2}Na₅(Mo_{0.5}W_{0.5}O₄)₄, Ce_{0.05}Gd_{0.05}Nd_{0.75}Yb_{0.15}Na₅(Mo_{0.7}Wo_{0.3}O₄)₄, Nd_{0.9}Yb_{0.1}Al_{3 (BO}₃)₄, Nd_{0.9}Yb_{0.1}Al_{2.7}Cr_{0.3}(BO₃)₄, Nd_{0.5}Yb_{0.4}P₃O₁₄, Nd_{0.8}Yb_{0.2}K₃(PO₄)₂ and the like may be used.

In this case, absorption spectrum or fluorescence spectrum can be varied by varying the kind of elements constituting the colorant and the composition ratio. Therefore, colorants having desired optical characteristics can be obtained. Further, the colorant is an inorganic crystal, which can withstand external factors such as heat and light and thus can stably exhibit the properties. In the present invention, these infrared-infrared fluorescent colorants can be preferably used. However, the colorant is not limited to these fluorescent colorants only.

The above infrared-infrared fluorescent colorant is mixed with or dispersed in a binder resin, a solvent, and optional additives to prepare a marking ink. Binder resins usable herein include polyester resins, polyacrylic ester resins, polystyrene resins, polyamide resins, polyvinyl butyral resins, polyvinyl alcohol resins, cellulose acetate resins, vinyl chloride resins, vinyl acetate resins, and melamine resins. Further, mixtures of these resins and copolymers of monomers constituting these resins, which have been cured by crosslinking with various crosslinking agents, may also be used. Additives include dispersants, thickeners, antifoaming agents, and coating face improvers.

The mixing ratio of the infrared-infrared fluorescent colorant to the main resin is about 30:100 to 300:100 on a solid weight ratio basis. When the mixing ratio of the fluorescent colorant is below the lower limit of the above-defined mixing ratio range, the luminescence intensity is too low to satisfactorily develop the function of the colorant. On the other hand, when the mixing ratio of the fluorescent colorant is above the upper limit of the above-defined mixing ratio range, a problem of dispersibility occurs, leading to problems of storage stability and suitability for coating of the ink. The mixing ratio of various additives may be properly determined.

The identification mark may be formed by printing the mark ink on a desired position in desired form and size and drying the print. Printing methods usable herein include various printing methods such as gravure printing, screen printing, and offset printing. If necessary, a method may be used wherein a thermal transfer sheet having a marking ink as a thermal transfer layer is previously prepared and the marking ink is transferred by a thermal transfer method using a heat source such as a thermal head on a desired position in desired form and size to form a mark.

The mark is preferably formed within the substrate sheet. For example, when the image forming sheet has a construction of

1) dye-receptive layer,

2) void-containing polypropylene film,

3) plain paper,

4) void-containing polypropylene film, and

5) backside layer

stacked in that order on top of one another, the identification mark is preferably provided between 2) void-containing polypropylene film and 3) plain paper or between 3) plain paper and 4) void-containing polypropylene film.

The void-containing polypropylene film is substantially white. Therefore, when this film and the like are stacked on the identification mark, the identification mark can be concealed without any special concealing treatment. More preferably, the identification mark is provided between 3) plain paper and 4) void-containing polypropylene film. This is because, when the mark is provided between 2) void-containing polypropylene film and 3) plain paper, very small thickness of the mark sometimes affects image formation. Also in this case, the mark can be sometimes effectively applied depending upon actual influence or by regulating the thickness of the mark.

The identification mark can be printed on the surface of any of 2) void-containing polypropylene film, 3) plain paper, and 4) void-containing polypropylene film without particular limitation. Preferably, however, the mark is printed on the surface of 3) plain paper because, by virtue of absorption properties of the plain paper, advantageously, the marking ink penetrates into the plain paper to reduce the mark thickness.

### Method for Identification of Image Forming Sheet

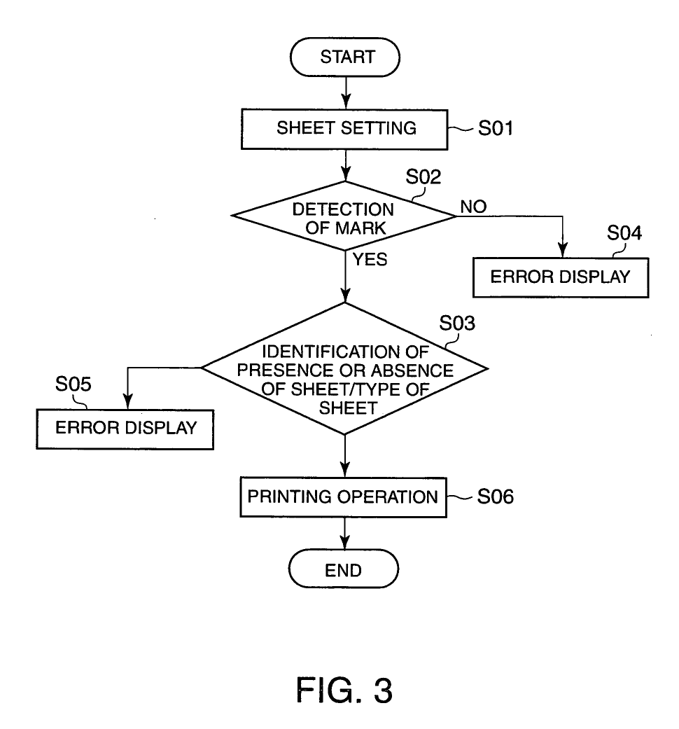

The identification method according to the present invention will be described with reference to FIG. 3 showing a flow chart illustrating a method for identifying the presence or absence of the image forming sheet and/or the type of the image forming sheet.

The image forming sheet is set in a feed part of an image forming apparatus (a printer) so that the image forming sheet can be fed into the printer (step S01).

Next, an electromagnetic radiation with a wavelength λ1 is emitted from a sensor. When an image forming sheet having an identification mark provided, within the inside of the image forming sheet, so as to be less likely to be visually perceived from the external appearance of the image forming sheet is present and exposed to the electromagnetic radiation with a wavelength λ1, the identification mark absorbs the applied electromagnetic radiation with a wavelength λ1 and emits an electromagnetic radiation which is then received in the sensor in its light receiving part which can detect an electromagnetic radiation with a wavelength λ2 different from the wavelength λ1. Whether or not the electromagnetic radiation with a wavelength λ2 was detected in the light receiving part of the sensor, is judged (step S02).

When the result of the judgment of the detection in step S02 is that the electromagnetic radiation with a wavelength λ2 was detected (S02: YES), a mark detection signal is compared with predetermined data in a discrimination part provided within the printer to identify the presence or absence of the image forming sheet and/or the type of the image forming sheet (step S03).

On the other hand, when the result of the judgment of the detection in step S02 is that the electromagnetic radiation with a wavelength λ2 was not detected (S02: NO), this detection result is sent from the discrimination part provided within the printer to a control unit and an error display is carried out on a display part of the printer (step S04) or alternatively the operation of the printer is stopped.

When the result of the comparison with predetermined data in the discrimination part in step S03 is that the mark detection signal is fit (good), next printing operation in the thermal transfer printer is started to form an image on the image forming sheet (step S06).

In step S03, when recognition as an image forming sheet cannot be made from the mark detection signal and/or when the type of the image forming sheet cannot be identified, an error display is carried out on the display part of the printer (step S05) or alternatively the operation of the printer is stopped.

In step S03, after the image forming sheet is recognized and/or the type of the image forming sheet is identified, the printer prints an image on the image forming sheet.

If necessary, the number of times of detection of the identification mark in the image forming sheet may be added up to calculate the quantity of used image forming sheet.

### Image Forming Apparatus

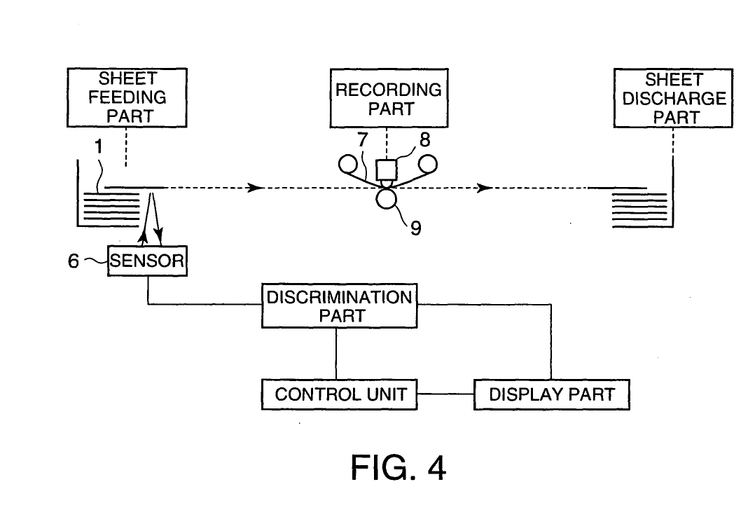

The image forming apparatus according to the present invention will be described with reference to FIG. 4.

FIG. 4 is a block diagram showing one embodiment of the image forming apparatus according to the present invention. In the image forming apparatus, an image forming sheet 1 is fed from a sheet feeding part. The image forming sheet shown in the drawing is in a sheet form. Alternatively, a continuous sheet, which has been wound up around a bobbin or the like, may also be used. The image forming sheet 1 is moved to a recording part, and the image forming sheet 1 and a thermal transfer sheet 7 are put on top of each other so that they are brought into contact with each other, followed by pressing of the assembly by means of a thermal head 8 and a platen roll 9 and heating according to image information (recording part).

The image forming sheet 1, on which an image has been formed in the recording part, is moved and discharged to a sheet discharge part where the discharged sheets are put on top of one another.

An identification mark, which is less likely to be visually perceived from the external appearance, is provided within the image forming sheet 1. A discrimination part is connected to a sensor 6 to detect the mark and to carry out discrimination treatment in the sheet feeding part, based on the detected signal, for identifying the presence or absence of the image forming sheet 1 and/or the type of the image forming sheet 1. The discrimination part is connected to a control unit for determining printing operation.

In the recording part, in such a state that the image forming sheet 1 fed from the sheet feeding part and the thermal transfer sheet 7 have been sandwiched between the thermal head 8 and the platen roll 9, the assembly is heated by means of the thermal head 8 for each color of yellow, magenta, cyan and the like according to image information to thermally transfer the colorants in the thermal transfer sheet 7 onto the image forming sheet 1.

The discrimination part is connected to the control unit for determining printing operation, and a display part for displaying warning in the printer, the type of sheet, the quantity of residual sheets and the like is connected to the discrimination part and the control unit.

The image forming sheet 1, on which an image has been formed in the recording part, is moved and is discharged to the sheet discharge part.

### EXAMPLES

The following examples and comparative examples further illustrate the present invention. In the following examples and comparative examples, “parts” or “%” is by weight.

### Example 1

### Preparation of Image Forming Sheet (Marking Ink)

| | |
|---|---|
| Colorant (IRS-F, manufactured by | 50 parts |
| NEMOTO & CO., LTD) | |
| Polyester resin (Vylon 200, manufactured | 100 parts |
| by Toyobo Co., Ltd.) | |
| Methyl ethyl ketone | 50 parts |
| Toluene | 50 parts |

An identification mark was provided on a substrate paper (Pearl Kote, 127.9 g/m², manufactured by Mitsubishi Paper Mills, Ltd.) by gravure printing with an marking ink having the above composition, and the identification mark was dried in a hot-air oven of 100° C. for 30 sec. The coverage of the identification mark was 1.8 g/m². The mark printed part was substantially white and thus was inconspicuous. However, the shape of the mark could be visually perceived, for example, when observed obliquely. Next, a coating liquid for an adhesive layer having the following composition was gravure coated on the identification mark side of the substrate paper at a coverage of 4.5 g/m² on a dry basis, and the coating was dried in a hot-air oven of 100° C. for 30 sec.

### Coating Liquid for Adhesive Layer

| | |
|---|---|
| Main agent (Takelac A-969V, manufactured | 30 parts |
| by Takeda Chemical Industries, Ltd.) | |
| Curing agent (Takenate A-5, manufactured | 10 parts |
| by Takeda Chemical Industries, Ltd.) | |
| Ethyl acetate | 60 parts |

Next, a 35 μm-thick polypropylene film having fine voids in its interior (Toyopearl SS P4255, manufactured by Toyobo Co., Ltd.) was laminated onto the substrate paper through the adhesive layer. This procedure was carried out on the surface of the substrate paper remote from the identification mark to laminate the polypropylene film on both sides of the substrate paper to prepare a substrate sheet.

Next, a coating liquid for an intermediate layer having the following composition was gravure coated onto the surface of the identification mark-free polypropylene film at a coverage of 2.0 g/m² on a dry basis, and the coating was dried in a hot-air oven of 100° C. for 30 sec. Further, a coating liquid for a receptive layer having the following composition was gravure coated on the intermediate layer at a coverage of 4.0 g/m² on a dry basis, and the coating was dried in a hot-air oven of 100° C. for 60 sec.

### Coating Liquid for Intermediate Layer

| | |
|---|---|
| Urethane resin (Nippollan 5199, | 10 parts |
| manufactured by Nippon Polyurethane | |
| Industry Co., Ltd.) | |
| Anatase titanium oxide | 10 parts |
| Methyl ethyl ketone/toluene | 20 parts |
| (mixing weight ratio = 1/1) | |
| Isopropyl alcohol | 5 parts |

### Coating Liquid for Receptive Layer

| | |
|---|---|
| Vinyl chloride-vinyl acetate copolymer | 20 parts |
| (1000 A, manufactured by Denki | |
| Kagaku Kogyo K.K.) | |
| Epoxy-modified silicone oil | 2 parts |
| (X-22-3000 T, manufactured by | |
| The Shin-Etsu Chemical Co., Ltd.) | |
| Methyl ethyl ketone/toluene | 76 parts |
| (mixing weight ratio = 1/1) | |

### Coating Liquid for Backside Layer

| | |
|---|---|
| Acrylic resin (BR 85, manufactured | 10 parts |
| by Mitsubishi Rayon Co., Ltd.) | |
| Nylon 12 filler (MW 330, manufactured | 2 parts |
| by Shinto Paint Co., Ltd.) | |
| Solvent (MEK/toluene, mixing weight | 88 parts |
| ratio = 1/1) | |

Next, a coating liquid for a backside layer having the above composition was gravure coated onto the substrate sheet, comprising the substrate paper and the polypropylene film laminated onto both sides of the substrate paper, in its side remote from the receptive layer at a coverage of 2.5 g/m² on a dry basis, and the coating was dried in a hot-air oven of 100° C. for 60 sec.

Thus, an image forming sheet (a thermal transfer image-receiving sheet) of Example 1 was prepared. In the image forming sheet thus obtained, the mark could not be substantially visually perceived.

### Example 2

An image forming sheet of Example 2 was prepared in the same manner as in Example 1, except that the coverage of the mark was changed to 5.0 g/m².

### Comparative Example 1

An image forming sheet of Comparative Example 1 was prepared in the same manner as in Example 1, except that the mark forming position was changed to the outermost surface on the backside of the image forming sheet, that is, the surface of the backside layer.

### Comparative Example 2

An image forming sheet of Comparative Example 2 for the evaluation of appearance was prepared in the same manner as in Example 1, except that the colorant contained in the coating liquid for mark formation was changed to commercially available carbon black.

For the image forming sheets of Examples 1 and 2 and Comparative Examples 1 and 2 thus prepared, the appearance was visually inspected under visible radiation for the perception of the identification mark. Evaluation results are shown in Table 1. The appearance was evaluated as “O” when the results were such that the mark could not be visually perceived with no practical problem, and the appearance was on a good level; the appearance was evaluated as “Δ” when the results were such that the mark could be slightly visually perceived with a some practical problem; and the appearance was evaluated as “x” when the results were such that the mark could be conspicuously perceived with a practical problem.

TABLE 1
(Evaluation of appearance)

| | Appearance | Evaluation |
|---|---|---|
| Example 1 | It was difficult to visually perceive the presence | ◯ |
| | of the mark on both image forming face and | |
| | backside of the sheet. | |
| Example 2 | It was difficult to visually perceive the presence | ◯ |
| | of the mark on both image forming face and | |
| | backside of the sheet. | |
| Comparative | When the sheet was visually inspected from | Δ |
| Example 1 | the backside, the mark part was substantially | |
| | white and inconspicuous, while, e.g., when | |
| | the sheet was visually inspected obliquely, | |
| | the shape of the mark could be visually | |
| | perceived. | |
| Comparative | When the sheet was visually inspected from the | X |
| Example 2 | backside, the shape of the black mark could be | |
| | visually perceived through the film. | |

Next, for the image forming sheets of the examples and the comparative examples prepared above, the wavelength and intensity of luminescence emitted upon exposure to excitation light were measured with a fluorescence spectrophotometer FP 6600 manufactured by Japan Spectroscopic Co., Ltd. A luminescence intensity ratio was determined by measuring the luminescence intensity for each example under identical measuring conditions and determining a relative intensity by presuming the luminescence intensity of Comparative Example 1 to be 1.

Based on the intensity level of luminescence emitted upon exposure to excitation light (absorption light), when the luminescence intensity ratio was not less than 0.5, the judgment was ⊚; when the luminescence intensity ratio was 0.4 to less than 0.5, the judgment was ∘; when the luminescence intensity ratio was 0.3 to less than 0.4, the judgment was Δ; and when the luminescence intensity ratio was less than 0.3, the judgment was x. In practice, in the case of “⊚” the mark can be detected with a sensor without any problem; in the case of “∘,” the mark can be detected with a sensor; in the case of “Δ,” the detection of the mark with a sensor is unstable; and in the case of “x,” the mark cannot be detected with any sensor.

The wavelength and intensity of luminescence emitted upon exposure to the excitation light, the luminescence intensity ratio, and the results of judgment are shown in Table 2.

TABLE 2

| | Absorption | | | |
|---|---|---|---|---|
| | wavelength | | | |
| | (excitation | Emission | | |
| | wavelength) | wavelength | Luminescence | |
| | (unit: nm) | (unit: nm) | intensity ratio | Judgment |
| Example 1 | 805 | 984 | 0.55 | ⊚ |
| Example 2 | 805 | 984 | 0.95 | ⊚ |
| Example 1 | 805 | 986 | 0.34 | Δ |
| (image | | | | |
| receiving | | | | |
| surface side) | | | | |
| Example 2 | 805 | 986 | 0.45 | ◯ |
| (image | | | | |
| receiving | | | | |
| surface side) | | | | |
| Comparative | 805 | 984 | 1 | — |
| Example 1 | | | | |
| Control | 805 | 984 | 0.16 | X |
| (no mark) | | | | |

In the case of Example 1 (image receiving surface side) and Example 2 (image receiving surface side), the excitation light was applied from the image receiving surface side, on which an image is to be formed, in the image forming sheet to measure the wavelength and intensity of luminescence. In the case of all the other examples, the excitation light was not applied from the image receiving surface side but from the backside of the image forming sheet to measure the wavelength and intensity of luminescence.

As described above, according to the present invention, the provision of an identification mark containing a material, which absorbs an infrared radiation with a wavelength λ1 and emits an infrared radiation with a wavelength λ2 different from the wavelength λ1, within an image forming sheet can realize reliable identification of the presence or absence of the image forming sheet and/or the type of the image forming sheet without sacrificing the appearance and design of the sheet. Specifically, since the material is substantially colorless or white under visible radiation, the presence or absence of an image forming sheet and/or the type of the image forming sheet can be reliably identified without sacrificing the design and appearance of the sheet, while reducing the visibility of the mark, by using an image forming sheet, prepared by printing a mark, on a substrate, using a mark forming ink containing this material, further stacking other substrate(s) and optionally providing an image forming layer (a receptive layer), and a mark detecting mechanism (a sensor) comprising a combination of a light source for applying an infrared radiation with a wavelength λ1 and a detector for detecting an infrared radiation with a wavelength λ2.

Further, since the infrared radiation has higher light transmittance for long wavelengths than the visible radiation, the use of the image forming sheet according to the present invention enables, for example, the mark to be detected also from the image forming sheet on its side remote from the mark.

1. An image forming sheet comprising an identification mark provided within said sheet, said mark being less likely to be visually perceived from the external appearance of said sheet.

2. The image forming sheet according to claim 1, which has a laminate structure of a plurality of substrate sheets and the identification mark is provided between said plurality of substrate sheets.

3. The image forming sheet according to claim 1 or 2, wherein said identification mark contains a material which is capable of absorbing an electromagnetic radiation with a wavelength λ1 and is capable of emitting an electromagnetic radiation with a wavelength λ2 different from the wavelength λ1.

4. The image forming sheet according to claim 3, wherein said electromagnetic radiation with a wavelength λ1 absorbed by said material is infrared radiation and said electromagnetic radiation with a wavelength λ2 emitted from said material is also infrared radiation.

5. The image forming sheet according to any one of claims 1 to 4, which is a thermal transfer image receiving sheet.

6. An identification method comprising the steps of: providing the image forming sheet according to any one of claims 1 to 5; and detecting the identification mark provided in the image forming sheet with a sensor to identify the presence or absence of the image forming sheet and/or the type of the image forming sheet.

7. An image forming apparatus comprising:
a sensor which, when the image forming sheet according to any one of claims 1 to 5 has been placed in said apparatus, detects the identification mark provided in the image forming sheet;
a discrimination means for performing discrimination for identifying the presence or absence of the image forming sheet and/or the type of the image forming sheet based on a signal detected by the sensor; and
a control unit for determining the operation of image formation based on the result of discrimination treatment.
